(19) United States
(12) Patent Application Publication
(10) Pub. No.: US 2019/0055104 A1
(43) Pub. Date: Feb. 21, 2019

(54) SYSTEM AND METHOD FOR NONINTRUSIVE DETECTION OF 3D FILAMENT JAMS AND RUNOUT

(71) Applicant: RoboGardens LLC, Flower Mound, TX (US)

(72) Inventor: Stephen Hayes, Flower Mound, TX (US)

(73) Assignee: RoboGardens LLC, Flower Mound, TX (US)

(21) Appl. No.: 15/679,486

(22) Filed: Aug. 17, 2017

(51) Int. Cl. B65H 63/036; B65H 63/08; B65H 49/32

(52) U.S. Cl. CPC B65H 63/0368; B29C 64/241; B65H 49/322; B65H 63/08

(57) ABSTRACT

A system, method and computer program product for detecting filament jams and filament runout conditions on Fused Deposition Modeling (FDM) 3D printers, including a filament feed sensor configured to detect feeding of a filament by a filament drive motor and provide a feeding status thereof; a filament drive motor sensor configured to detect movement of the filament drive motor and provide a movement status thereof; and a processor configured to compare the feeding status and the movement status to detect at least one of a filament jam and filament runout condition on a Fused Deposition Modeling (FDM) 3D printer.

### BACKGROUND OF THE INVENTION

### Field of the Invention

The present invention generally relates to 3D printing systems and methods, and more particularly to a method and system for detecting filament jam, filament runout, and the like, conditions in Fused Deposition Modelling (FDM) printers, and the like.

### Discussion of the Background

Fused Deposition Modelling (FDM) printers represent the most common type of 3D printer. Typically, the printer is fed by spool of thermoplastic filament. This filament is melted and extruded in the shape of the desired model. For example, faults can occur with FDM printers related to extrusion failures, and the like, such a filament jams, and the like. For various reasons, such as a clogged nozzle, heat creep, improperly sized filament, and the like, the filament can become blocked and is no longer extruding. In addition, filament runouts, and the like, can also occur. For example, the spool of filament is used up, so the printer continues printing, but is just printing air. Solutions for detecting filament jam and runout exist. However, these require either manual activation or integration with the printers. Detecting that the filament is moving is easy. Enabling the filament detection only when it is supposed to be moving poses a challenge. Existing solutions require either manual activation of a watching mode that monitors the filament when the user knows it should be extruding or integration with the 3D printer firmware. In the latter case, signals from the filament motion sensor are sent to the 3D printer which knows when filament should be extruded. Most printers do not have this capability or require custom firmware to enable such function. However, if such conditions can be detected rapidly enough, then the operator can intervene and correct the problem so that the print can complete successfully.

### SUMMARY OF THE INVENTION

Therefore, there is a need for a method and system that addresses the above and other problems. The above and other problems are addressed by the illustrative embodiments of the present invention, which provide a solution to detect filament jams, runout conditions, and the like, automatically on a printer (e.g., Fused Deposition Modelling (FDM) printers) without a need for custom firmware support in the 3D printer. Each extruder in a 3D printer has a motor that drives that extruder and feeds the filament. Accordingly, in an illustrative embodiment, a first sensor, such as a magnometer, and the like, can be attached to a side of the motor. Advantageously, by sensing the changing magnetic field of the motor, the system knows when the extruder motor is running. Advantageously, by comparing such detection with motion detected, for example, by a filament sensor, the system can determine when a filament jam, runout situation, and the like, has occurred. In addition, the operator can be notified of such situations. Further, if the printer has hardware capability to pause jobs, and the like, then such functions, and the like, can be triggered as well, based on the sensor results, and the like.

Accordingly, in illustrative aspects of the present invention there is provided a system, method, and computer program product for detecting filament jams and filament runout conditions on Fused Deposition Modeling (FDM) 3D printers, including a filament feed sensor configured to detect feeding of a filament by a filament drive motor and provide a feeding status thereof; a filament drive motor sensor configured to detect movement of the filament drive motor and provide a movement status thereof; and a processor configured to compare the feeding status and the movement status to detect at least one of a filament jam and filament runout condition on a Fused Deposition Modeling (FDM) 3D printer.

The processor is configured to process the feeding status and the movement status by applying an averaging and hysteresis threshold to detect when the filament is being unsuccessfully driven by the filament drive motor to detect the filament jam or the filament runout condition.

The system, method, and computer program product can include a communications link coupled to the processor and configured to at least one of alert a user of the filament jam or the filament runout condition, and send a signal to the 3D printer to pause printing until the filament jam or the filament runout condition is cleared.

The system, method, and computer program product can include an interface coupled to the processor and configured as a dedicated pause control line for the 3D printer having a remote pause capability.

The processor is configured to alert a user that a print job has completed when both the filament and the motor sensor have quiesced simultaneously.

The filament feed sensor is a rotary encoder or an optical tracker, and the filament motor sensor is a magnetometer or hall affect sensor.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows an illustrative mechanism for detecting filament jams, runouts, and the like, and alerting an operator of such problems, and the like; and

FIG. 2 shows illustrative logic used by a processor to determine when a filament jam, runout, and the like, has occurred.

### DETAILED DESCRIPTION OF THE PREFERRED EMBODIMENTS

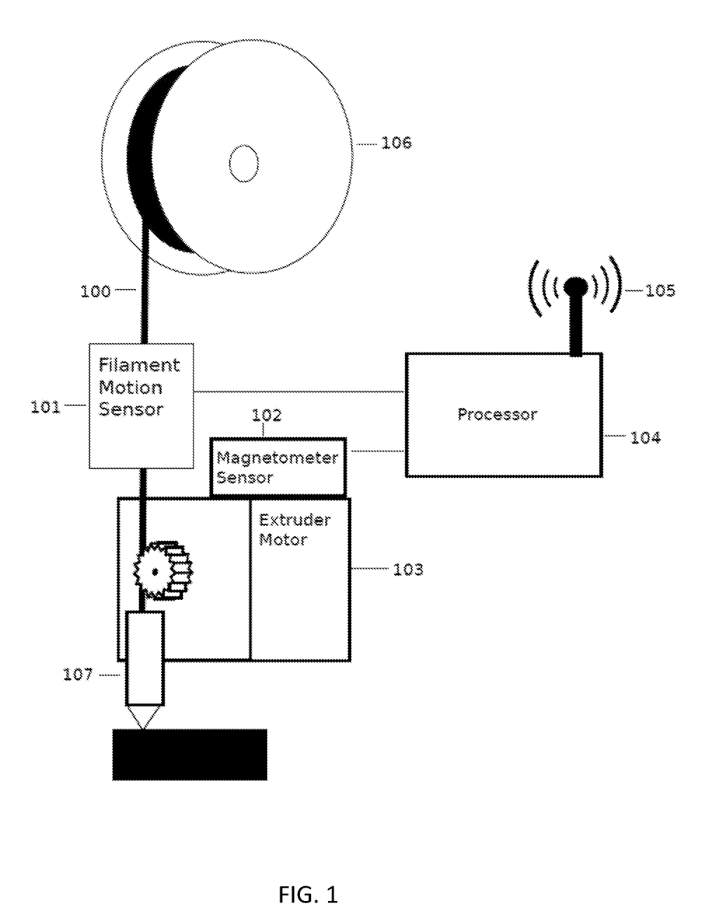

Referring now to the drawings, wherein like reference numerals designate identical or corresponding parts throughout the several views, and more particularly to FIG. 1 thereof, there is shown an illustrative mechanism for detecting filament jams, runouts, and the like, and alerting an operator of such problems, and the like. In FIG. 1, filament 100 is fed from a spool 106 by a motor 103, for example, as employed on Fused Deposition Modelling (FDM) printers, and the like. Advantageously, the system can detect a situation in which the system is trying to extrude the filament 100 by running the extruder motor 103, but the filament 100 is not advancing. For example, such a problem can occur because there is a jam in the extrusion mechanism 107, because the spool 106 is empty, and the like.

The filament 100 motion is detected by a filament sensor 101, for example, including rotary encoders, optical sensors, such as those employed in optical mice, and the like. The extruder motor 103 activity is detected by a magnometer sensor 102, and the like. Although stepper motors 103 of the type used in 3D printers are well shielded, it is possible to detect their changing magnetic field with the sensor 102 sufficiently close to the motor 103 body. A processor 104 combines the input of the sensors 101 and 102, and when the processor 104 detects extruder motor 103 activity without corresponding filament 100 motion, an alarm, and the like, can be triggered.

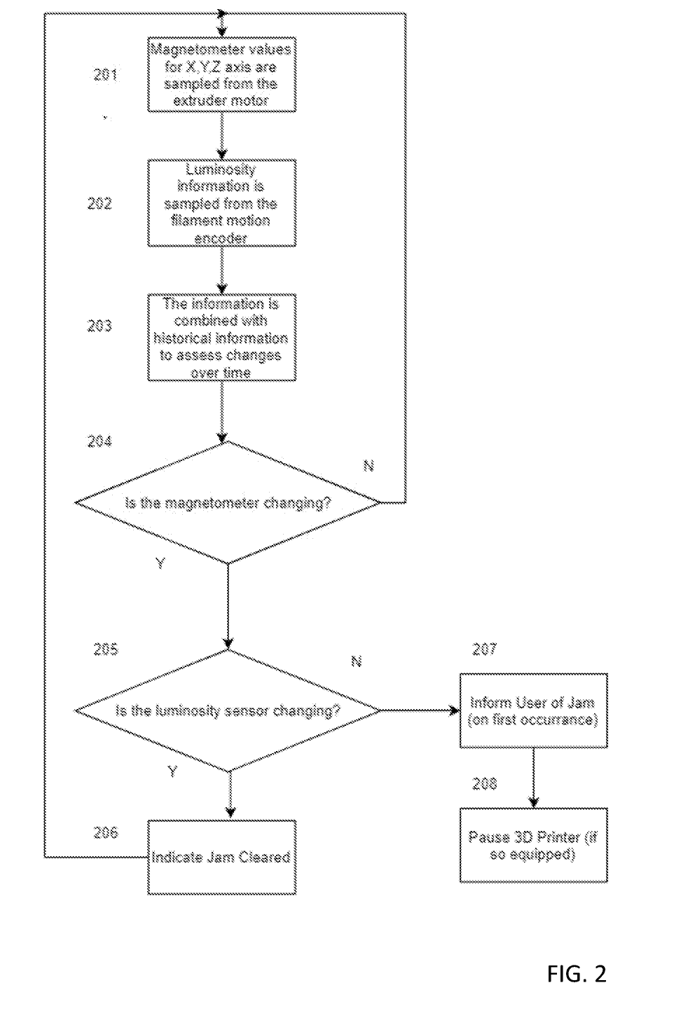

FIG. 2 shows illustrative logic used by a processor to determine when a filament jam, runout, and the like, has occurred. In FIG. 2, an overview of the logic used to detect jams is presented, wherein at step 201, the output from the magnetometer 102 attached to the side of the extruder motor 103 is sampled by the processor 104. When the motor 103 is running, the magnetic fields are changing along multiple axes. In step 202, the output from the encoder 101 attached to the filament 100 is sampled by the processor 104. If the filament 100 is moving, then the encoder 101 output changes.

In step 203, the collected information from sensors 101 and 102 is combined by the processor 104 with other historical change information, and the like. Advantageously, this prevents anomalous inputs from triggering false alarms, and the like. In step 204, an assessment is made by the processor 104 of whether the extruder motor 103 is running. Such assessment is based on the intensity of magnetic field variation, as detected by the sensor 102. If the field is not changing, then the motor 103 is not running, so no jam can occur. In step 205, an assessment is made of whether the filament 100 is moving. Such assessment is made by the processor 104, based on feedback from the encoder 101 attached to the filament 100. If the filament 100 is moving, it means that there is no jam. In step 206, any previous jam indication is cleared. If the filament 100 was not moving, it means that the motor 103 is running, but filament 100 is not being extruded, for example, during a jam, a runout, and the like. The user is alerted by the processor 104 of such a situation in step 207. In step 208, some 3D printers can be triggered to pause if filament 100 runouts, and the like, are detected. If so, this can be triggered by the processor 104, which can pause the printing, and the like.

Accordingly, the system, method and computer program product can include detecting filament jams and filament runout conditions on FDM 3D printers, including a sensor to detect feeding of the filament, a sensor to detect movement of the filament drive motor, and a processor to compare the two readings. The processing of the sensor input can be performed applying appropriate averaging and hysteresis threshold to detect when the filament is being unsuccessfully driven by the drive motor. Such a condition indicates a filament jam or runout. A communications link can be provided to alert the user of a jam or filament runout condition. A communications link can be provided to signal the 3D printer to pause printing until the jam or filament runout is cleared. An interface for a dedicated pause control line can be provided for those printers equipped with remote pause capability. The system also can alert the user that a print job has completed when both the filament and the motor sensor have quiesced simultaneously. The filament feed sensor can be a rotary encoder, and the motor sensor can be a magnetometer. In addition, any other suitable types of sensors can be employed, for example, such as an optical tracker to detect filament motion (e.g., like in an optical mouse), a hall affect sensor on the motor power lines, and the like.

The above-described devices and subsystems of the illustrative embodiments can include, for example, any suitable servers, workstations, PCs, laptop computers, microcomputers, microcontrollers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, flash memory, SSD, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, integrated development environment, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for detecting filament jams and filament runout conditions on Fused Deposition Modeling (FDM) 3D printers, the system comprising:
a filament feed sensor configured to detect feeding of a filament by a filament drive motor and provide a feeding status thereof;
a filament drive motor sensor configured to detect movement of the filament drive motor and provide a movement status thereof; and
a processor configured to compare the feeding status and the movement status to detect at least one of a filament jam and filament runout condition on a Fused Deposition Modeling (FDM) 3D printer.

2. The system of claim 1, wherein the processor is configured to process the feeding status and the movement status by applying an averaging and hysteresis threshold to detect when the filament is being unsuccessfully driven by the filament drive motor to detect the filament jam or the filament runout condition.

3. The system of claim 1, further comprising:
a communications link coupled to the processor and configured to at least one of:
alert a user of the filament jam or the filament runout condition, and
send a signal to the 3D printer to pause printing until the filament jam or the filament runout condition is cleared.

4. The system of claim 1, further comprising:
an interface coupled to the processor and configured as a dedicated pause control line for the 3D printer having a remote pause capability.

5. The system of claim 1, wherein the processor is configured to alert a user that a print job has completed when both the filament and the motor sensor have quiesced simultaneously.

6. The system of claim 1, wherein the filament feed sensor is a rotary encoder or an optical tracker, and the filament motor sensor is a magnetometer or hall affect sensor.

7. A method for detecting filament jams and filament runout conditions on Fused Deposition Modeling (FDM) 3D printers, the method comprising:
detecting with a filament feed sensor feeding of a filament by a filament drive motor and providing a feeding status thereof;
detecting with a filament drive motor sensor movement of the filament drive motor and provide a movement status thereof; and
comparing with a processor the feeding status and the movement status for detecting at least one of a filament jam and filament runout condition on a Fused Deposition Modeling (FDM) 3D printer.

8. The method of claim 7, further comprising processing with the processor the feeding status and the movement status by applying an averaging and hysteresis threshold to detect when the filament is being unsuccessfully driven by the filament drive motor to detect the filament jam or the filament runout condition.

9. The method of claim 7, further comprising:
coupling a communications link to the processor for at least one of:
alerting a user of the filament jam or the filament runout condition, and
sending a signal to the 3D printer to pause printing until the filament jam or the filament runout condition is cleared.

10. The method of claim 7, further comprising coupling an interface to the processor as a dedicated pause control line for the 3D printer having a remote pause capability.

11. The method of claim 7, further comprising alerting a user with the processor that a print job has completed when both the filament and the motor sensor have quiesced simultaneously.

12. The method of claim 7, wherein the filament feed sensor is a rotary encoder or an optical tracker, and the filament motor sensor is a magnetometer or hall affect sensor.

13. A computer program product for detecting filament jams and filament runout conditions on Fused Deposition Modeling (FDM) 3D printers and including one or more computer readable instructions embedded on a tangible, non-transitory computer readable medium and configured to cause one or more computer processors to perform the steps of:
detecting with a filament feed sensor feeding of a filament by a filament drive motor and providing a feeding status thereof;
detecting with a filament drive motor sensor movement of the filament drive motor and provide a movement status thereof; and
comparing with a processor the feeding status and the movement status for detecting at least one of a filament jam and filament runout condition on a Fused Deposition Modeling (FDM) 3D printer.

14. The computer program product of claim 13, further comprising processing with the processor the feeding status and the movement status by applying an averaging and hysteresis threshold to detect when the filament is being unsuccessfully driven by the filament drive motor to detect the filament jam or the filament runout condition.

15. The computer program product of claim 13, further comprising:
coupling a communications link to the processor for at least one of:
alerting a user of the filament jam or the filament runout condition, and
sending a signal to the 3D printer to pause printing until the filament jam or the filament runout condition is cleared.

16. The computer program product of claim 13, further comprising coupling an interface to the processor as a dedicated pause control line for the 3D printer having a remote pause capability.

17. The computer program product of claim 13, further comprising alerting a user with the processor that a print job has completed when both the filament and the motor sensor have quiesced simultaneously.

18. The computer program product of claim 13, wherein the filament feed sensor is a rotary encoder or an optical tracker, and the filament motor sensor is a magnetometer or hall affect sensor.
